(19) United States
(12) Patent Application Publication
(10) Pub. No.: US 2008/0300944 A1
(43) Pub. Date: Dec. 4, 2008

(54) RELEVANT INVITEE LIST FOR CONFERENCE SYSTEM

(75) Inventors: Luke Surazski, San Jose, CA (US); John A. Toebes, Cary, NC (US)

Correspondence Address: CISCO SYSTEMS, INC.;SCIENTIFIC-ATLANTA, INC., SA/CISCO IP DEPT., 5030 SUGARLOAF PARKWAY, LAWRENCEVILLE, GA, 30044, US

(73) Assignee: Cisco Technology, Inc., San Jose, CA (US)

(21) Appl. No.: 11/756,098

(22) Filed: May 31, 2007

(51) Int. Cl. G06Q 10/00; G06F 17/30; G06F 17/40

(52) U.S. Cl. 705/8; 707/104.1

(57) ABSTRACT

Methods and apparatus for providing a list of suggested attendees for a meeting that is being scheduled using a conferencing system are disclosed. According to one aspect of the present invention, a conferencing system includes an interface that receives a keyword associated with a meeting. The system also includes a data store that stores information, logic that searches the data store to determine if a first association between the keyword and a first entity of the plurality of entities is stored, and logic that identifies the first entity as a suggested attendee for the meeting if it is determined that the association between the keyword and the entity is stored in the data store.

### BACKGROUND OF THE INVENTION

1. Field of Invention

The present invention relates generally to communications systems. More particularly, the present invention relates to automatically generating a list of suggested attendees for a meeting based on descriptive input provided to a meeting scheduling system.

2. Description of the Related Art

Conference systems, e.g., conference systems associated with voice over internet protocol (VoIP) communications, often enable a user to schedule meetings. Such meetings may be “attended” by calling into the meeting using a telephone or a computing device. When a user, or an individual who schedules meetings using a conference system, wishes to invite other individuals to a meeting, the user typically enters identifying information pertaining to the individuals into a meeting scheduling interface of the conference system. Often, the identifying information for each invitee is either a user identifier (userid) for the invitee that is recognized within an enterprise which includes the conference system, or an e-mail address for the invitee. Once identifying information for each invitee is entered into a meeting scheduling interface for a particular meeting, a meeting invitation may be sent to each invitee. As will be appreciated by those skilled in the art, each invitee may then either accept the invitation to the meeting or decline the invitation to the meeting. When the invitee is in attendance at the meeting and is, hence, an attendee, the attendee may send an indication to the conference system that he or she is in attendance.

Determining the right people to invite to a meeting may be difficult, as it is not always clear who should, or would be likely to, attend the meeting. By way of example, there may be various groups or teams working on a project, but not working closely enough that the members of one team know the members of the other team. A user that is a member of a project development team may not know which members of the financial team are responsible for the finances of the project. Hence, the user may not know who to invite to a meeting to discuss all aspects of the project. Similarly, someone outside of the project development team may wish to meet with the project development team, but may know substantially only the name of the project, and not the identities of any members of the project development team.

The determination of who is appropriate to invite to a meeting is often a tedious task, as associations between a particular topic, e.g., a project, and individuals may be difficult to ascertain. Often, the associations between topics and individuals are discovered or otherwise identified through the exchange of telephone calls and e-mails.

Therefore, what is desired is a system which enables a user to readily determine who to invite to meetings for certain topics. That is, what is needed is a method and an apparatus that obtains a topic from a user and provides the user with a list of individuals that have an association with the topic.

### BRIEF DESCRIPTION OF THE DRAWINGS

The invention may best be understood by reference to the following description taken in conjunction with the accompanying drawings in which:

FIG. 1 is a diagrammatic representation of an enterprise which includes entities that are associated with an overall project and a conferencing system that may be used to invite the entities to a meeting in accordance with an embodiment of the present invention.

FIG. 2A is a diagrammatic representation of a conferencing system, e.g., conferencing system 112 of FIG. 1, that generates suggested inclusion lists for different keywords associated with a project in accordance with an embodiment of the present invention.

FIG. 2B is a diagrammatic representation of a conferencing system, e.g., conferencing system 112 of FIG. 1, that generates suggested inclusion lists which may be used as a basis to generate actual lists of invitees in accordance with an embodiment of the present invention.

FIG. 2C is a diagrammatic representation of information relating to suggested and actual invitee lists, e.g., suggested invitee lists 228a, 228b and actual invitee lists 236a, 236b of FIG. 2B, being provided to a user context arrangement, e.g., user context arrangement 124 of FIG. 1, in accordance with an embodiment of the present invention.

FIG. 3 is a block diagram representation of a graphical user interface (GUI) for a meeting scheduler that provides a list of suggested attendees for a meeting in accordance with an embodiment of the present invention.

FIG. 4A is a block diagram representation of a GUI for a meeting scheduler into which an entry of a meeting title and an entry of a meeting description cause a list of suggested attendees to be displayed in accordance with an embodiment of the present invention.

FIG. 4B is a block diagram representation of a GUI, i.e., GUI 436 of FIG. 4A, that has been used to select an invitee from a list of suggested attendees in accordance with an embodiment of the present invention.

FIG. 4C is a block diagram representation of a GUI that displays a list of suggested attendees ordered by the strengths of job titles in accordance with an embodiment of the present invention.

FIG. 4D is a block diagram representation of a GUI that displays a list of suggested attendees ordered by association strengths in accordance with an embodiment of the present invention.

FIG. 5 is a block diagram representation of a user context arrangement, i.e., user context arrangement 124 of FIG. 1, in accordance with an embodiment of the present invention.

FIG. 6 is a process flow diagram which illustrates a method of generating an association strength in accordance with an embodiment of the present invention.

FIG. 7 is a process flow diagram which illustrates a method of utilizing a message scheduling interface that provides a list of suggested attendees in accordance with an embodiment of the present invention.

FIG. 8 is a process flow diagram which illustrates a method of presenting a list of suggested attendees in accordance with an embodiment of the present invention.

### DETAILED DESCRIPTION OF THE EMBODIMENTS

Generating a dynamic set of associations between topics, groups, and individuals within a conference system allows the conferencing system to present an individual who is scheduling a meeting with a list of suggested groups and/or individuals to consider inviting to a meeting. That is, associations between topics, groups, and individuals that are generated based on information, e.g., historical information, maintained by the conference system may be used to provide a user with a list of groups and/or individuals that have previously been associated with a topic or description of a meeting that is being scheduled by the user. In one embodiment, the dynamic set of associations may be generated to include roles or functions assigned to the individuals.

When a meeting is scheduled within a conferencing system such as Cisco® MeetingPlace, available commercially from Cisco Systems, Inc. of San Jose, Calif., the meeting is generally associated with at least a title. The meeting may also be associated with a description. Indexing information contained in the title, as well as in the description, renders the information searchable. Hence, keywords are created based on the indexed information.

Invitees to a meeting may elect to attend the meeting. Once an invitee either attends a meeting or indicates an intention to attend a meeting, the user is associated with at least the meeting topic. In other words, identifying information of an attendee of a meeting may be associated with at least one keyword that is indexed from the meeting topic and, in some instances, a meeting description. The identifying information may include, but is not limited to including, a user identifier (userid) for the invitee, a profile, an e-mail address, and a telephone number. The identifying information of the attendee may be tied into a keyword such that a conferencing system may be aware that the attendee is likely to be relevant to substantially any meeting that has a topic or a description that includes the keyword.

An association between an individual, e.g., an individual who is a potential invitee, and a keyword may include an association strength. The association strength may be indicative of how likely the individual would be to attend a meeting with a topic or a description that includes the keyword. In one embodiment, an association strength may be measured as the frequency with which the user attend meetings associated with the keyword, and/or how recently the user attended a meeting associated with the keyword.

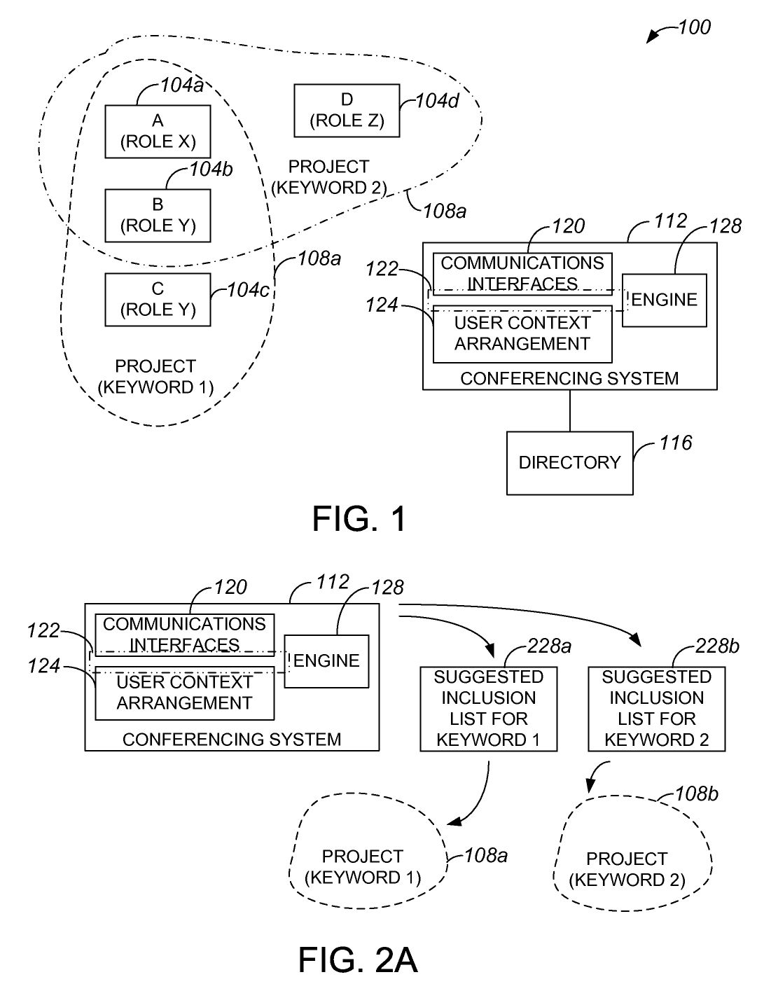

FIG. 1 is a diagrammatic representation of an enterprise within which a conferencing system that utilizes associations between keywords for a meeting and potential attendees of the meeting may be implemented in accordance with an embodiment of the present invention. An enterprise 100 includes a conferencing system 112 and a plurality of entities 104a-d that have roles within enterprise 100. Entities 104a-d may generally be individuals, e.g., individuals who have connectivity access to conferencing system 112 via telephones or computing devices, or groups of individuals.

Entities 104a-d may each be associated with a project. However, within the project, entities 104a-c are in a first group 108a associated with a first keyword for the project, and entities 104a, 104b, 104d are in a second group 108b associated with a second keyword for the project. By way of example, entities 104a-d may each be involved with “Project P,” while first group 108a is associated with “engineering” as a keyword and second group 108b is associated with “management” as a keyword. Entities 104a, 104b are effectively associated with both the “engineering” keyword and the “management” keyword.

Conferencing system 112 may associate keywords to groups 108a, 108b and, further, with entities 104a-d. By way of example, when conferencing system 112 is used to schedule a meeting involving “Project P engineering,” conferencing system 112 may identify entities 104a-d as potentially being interested in attending the meeting. Additionally, conferencing system 112 may provide an indication that group 108a may have more interest in the meeting than group 108b, as group 108b is generally associated with “Project P management.”

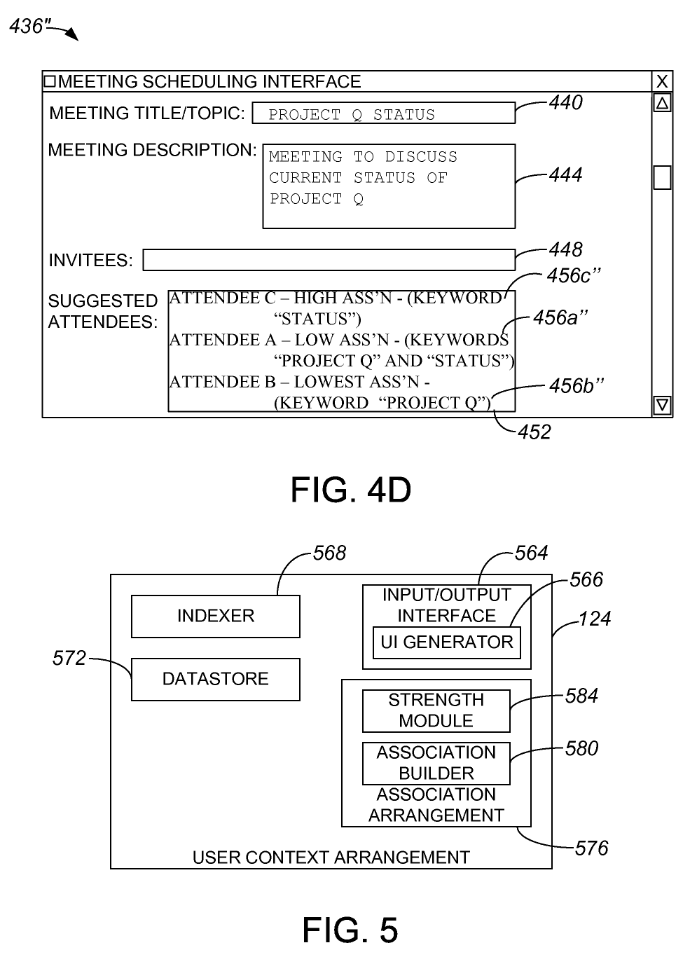

Conferencing system 112 is arranged to allow meetings to be scheduled, e.g., meetings that may be “attended” using communications interfaces 120. Communications interfaces 120 are arranged to allow entities 104a-d to interface with conferencing system 112, and may include, but are not limited to including, a wireless communications interface and a wired communications interface. A user context arrangement 124 of conferencing system 112, which will be described in more detail below with respect to FIG. 5, allows associations between keywords and entities 104a-d to be identified and maintained. An engine 128 allows the execution of functionality that allows user context arrangement 124 to generate a list of suggested invitees or suggested attendees to a given meeting. A scheduler 122, which is arranged to allow meetings to be scheduled, may utilize communications interfaces 120, user context arrangement 124, and engine 128. Scheduler 122 and user context arrangement 124 may generally include hardware logic and/or software logic, e.g., code devices, that implements functionality associated with scheduler 122 and user context arrangement 124. Software logic may be embodied on a tangible medium such as a computer-readable medium, or may be embodied as data signals of a carrier wave.

Conferencing system 112 may have access to a directory 116 that includes information about entities 104a-d. Directory 116 may be a database that is accessible by using a lightweight directory access protocol (LDAP). Within enterprise 100, director 116 may store information associated with entities 104a-d that includes, but is not limited to, titles and job functions.

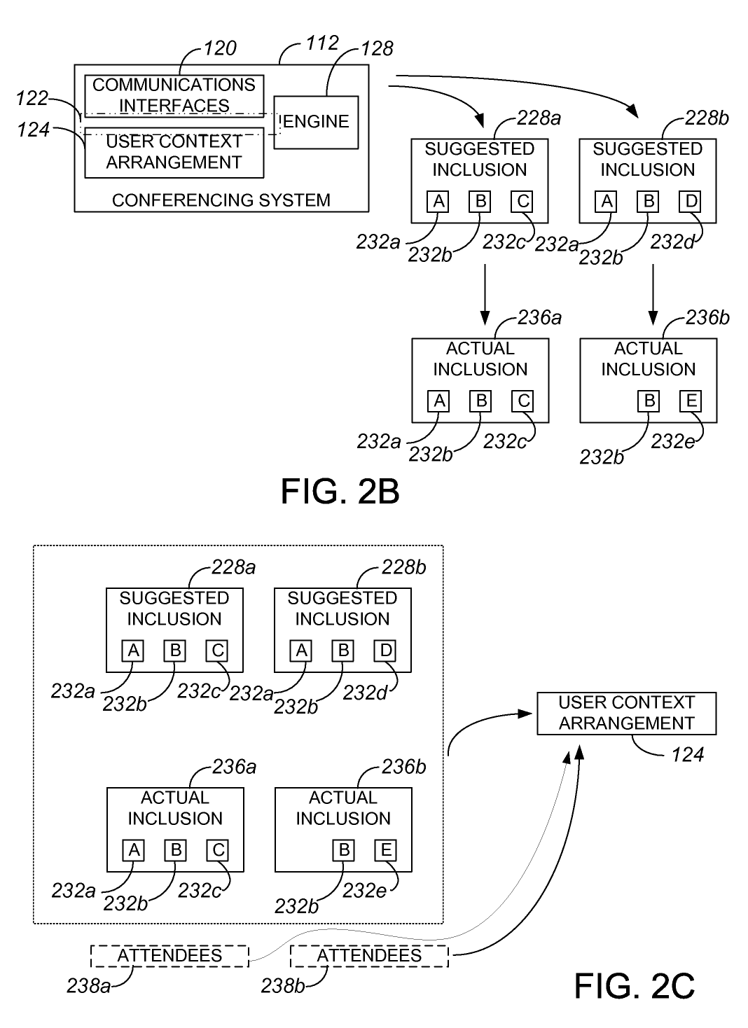

When a user schedules a meeting using conferencing system 112 or, more specifically, scheduler 122, the user may provide at least one keyword. A keyword may be included in a meeting topic or a meeting description. Using the keyword, conferencing system 112 may identify entities 104a-d that are potentially likely to attend a meeting that has a topic or a description that includes the keyword. With reference to FIG. 2A, the generation of suggested inclusion lists for different keywords will be described in accordance with an embodiment of the present invention. Given a first keyword string, e.g., “Project P engineering,” conferencing system 112 may generate a suggested inclusion list 228a that identifies group 108a. In other words, entities 104a-c are included in a suggested inclusion list 228a that includes suggested invitees, or likely attendees, of a meeting that has a topic or description that includes the first keyword. Similarly, given a second keyword, e.g., “Project P management,” conferencing system 112 may generate a suggested inclusion list 228b that identifies group 108b. It should be appreciated that a conferencing system is often used to schedule one meeting at a time. However, for purposes of illustration and discussion, FIG. 2A depicts scheduling associated with two meetings.

A user, or an individual that is scheduling a meeting, may generate actual invitee lists based on suggested inclusion lists 228a, 228b. As shown in FIG. 2B, an actual inclusion list 236a may be created using suggested inclusion list 228a, and an actual inclusion list 236b may be created using suggested inclusion list 228b. Suggested inclusion list 228a includes identifiers 232a-c for entities, e.g., entities 104a-c of FIG. 1, which are suggested as being relevant to a meeting that is at least partially described by a first keyword, and suggested inclusion list 228b includes identifiers 232a, 232b, 232d for entities, e.g., entities 104a, 104b, 104d of FIG. 1, that are suggested as being relevant to a meeting that is at least partially described by a second keyword. When presented with suggested inclusion lists 228a, 228b, a user who is scheduling a meeting may create corresponding actual inclusion lists 236a, 236b that include identifiers 232a-d for actual invitees to a meeting. Actual inclusion lists 236a, 236b may include none, some, or all of the suggested invitees indicated in suggested inclusion lists 228a, 228b, respectively. In addition, actual inclusion list 236b may include an indicator 232e for an entity that is not included in suggested inclusion list 232b, but that the user who is scheduling the meeting believes to be a likely attendee. That is, actual inclusion lists 236a, 236b may be subsets or supersets of suggested inclusion lists 232a, 232b, respectively, or may have no relationship to suggested inclusion lists 232a, 232b.

The actual attendees of a meeting may be all or fewer than all of the actual invitees to the meeting. In other words, not all actual invitees to a meeting may attend a meeting. Information pertaining to the actual attendees of a meeting may be used by the conferencing system to update the associations between keywords and entities. FIG. 2C is a diagrammatic representation of information suitable for use in updating associations being provided to a user context arrangement, e.g., user context arrangement 124 of FIG. 1, in accordance with an embodiment of the present invention. Information corresponding to the contents of suggested inclusion lists 228a, 228b, and information corresponding to actual inclusion lists 236a, 236b is provided to user context arrangement 124 such that user context information may be updated. Attendee information 238a, 238b that indicates which invitees identified in actual inclusion lists 236a, 236b, respectively, attended relevant meetings is provided to user context arrangement 124. User context arrangement 124 may update associations, e.g., the strengths of associations, based on which invitees in actual inclusion lists 236a, 236b became actual attendees 238a, 238b, respectively. By way of example, if an actual invitee does not attend a meeting, the association between the invitee and keywords that are relevant to the meeting may effectively be downgraded. In one embodiment, as an indicator 232a in suggested inclusion list 228b is not included in actual inclusion list 236b, an association between a second keyword and entity 104a of FIG. 1 may be updated to indicate a lower strength or ranking. The system may choose not to downgrade an association if it is able to determine that they were not available for other reasons, including already participating in another meeting that the conferencing system is aware of.

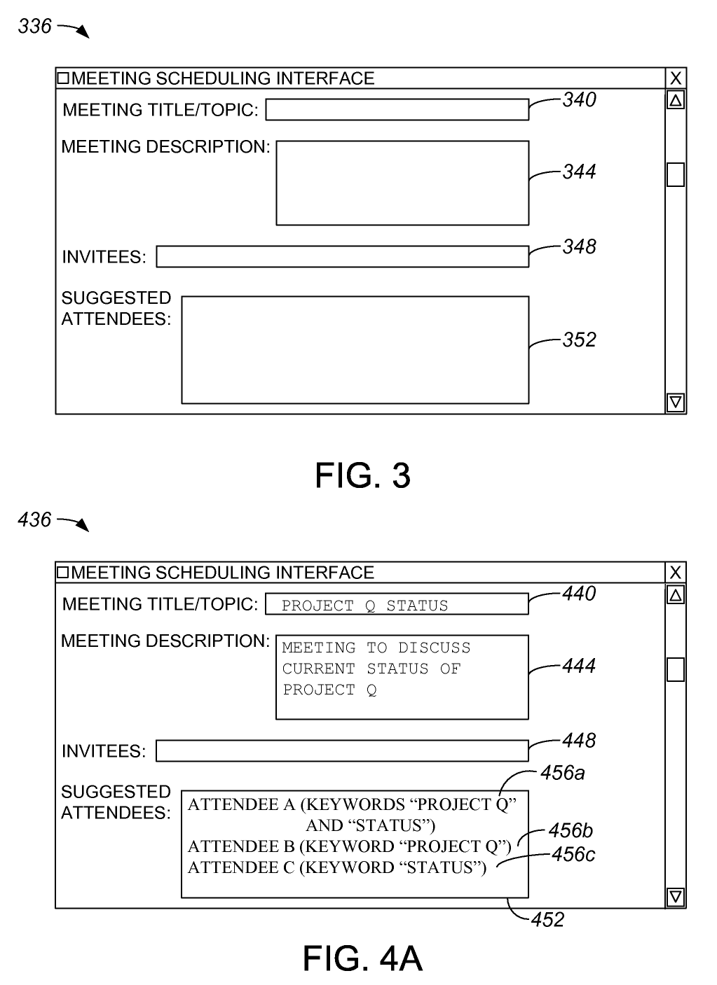

When a user is interacting with conferencing system 112 to schedule a meeting, the interaction may occur though an input/output interface that is presented to the user by conferencing system 112. In one embodiment, the interaction occurs through a graphical user interface (GUI) displayed on a display screen, e.g., a display screen of a computing system that is in communication with conferencing system 112. FIG. 3 is a block diagram representation of a GUI for a conferencing system that provides a list of suggested attendees for a meeting in accordance with an embodiment of the present invention. A GUI 336, which may be a browser window, includes a meeting title or topic field 340 into which a user may input a meeting title or topic. A description of the meeting may be entered into a meeting description field 344. Meeting description field 344 may also include information pertaining to an agenda, and references to documents and products. Various other fields (not shown) may be included to enable a user to enter information relevant to scheduling a meeting. Such information may include, but is not limited to, a date and time for a meeting, and a location for the meeting.

Once meeting title field 340 is populated with at least one keyword, the conferencing system may fill in suggested attendees or suggested invitees into a field 352. It should be appreciated that if meeting description field 344 is populated, the suggested attendees listed in field 352 may be updated to include suggested attendees that are associated with keywords filled into meeting description field 344. An invitee field 348 may be populated substantially automatically when a user selects a suggested attendee from field 352, or when the user manually enters invitees.

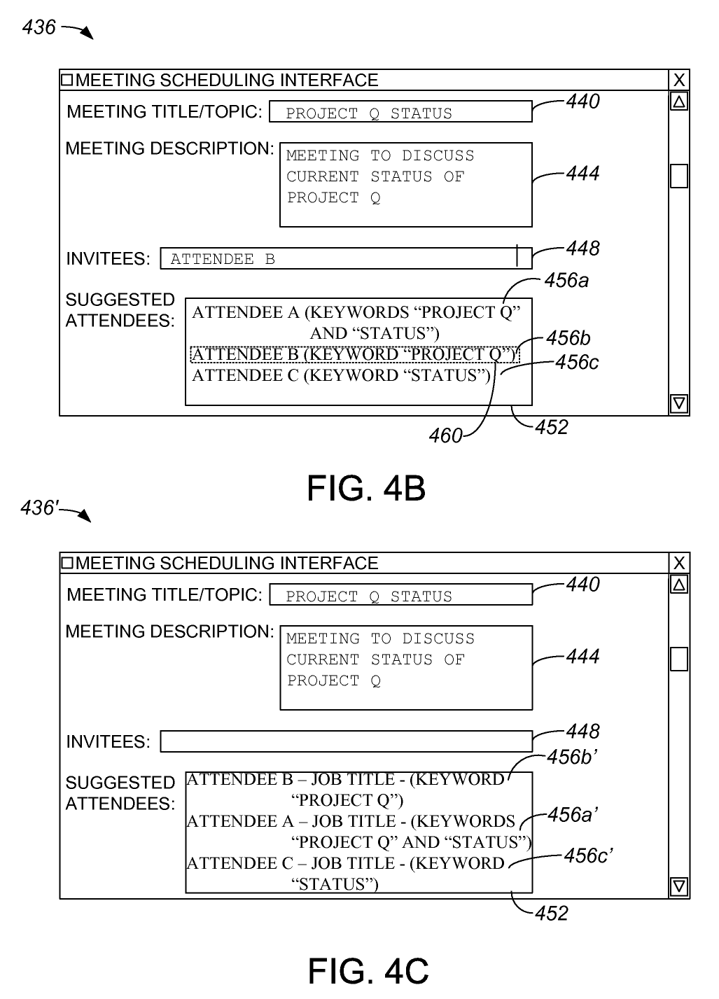

With reference to FIG. 4A, the use of a GUI that provides a list of suggested invitees to a meeting that is being scheduled will be described in accordance with an embodiment of the present invention. A GUI 436 includes a meeting title field 440 into which a character string has been entered by a user. In the embodiment as shown, the character string is “PROJECT Q STATUS.” A meeting description string that reads “MEETING TO DISCUSS CURRENT STATUS OF PROJECT Q” is entered into a field 444.

Substantially any words or combination of words in the strings entered into field 440 and field 444 may be identified as keywords. By way of example, “PROJECT Q” and “STATUS” may be identified as substantially separate keywords.

When strings are entered into field 440 and field 444, if there are there are potential attendees who have associations with keywords in the strings, the potential attendees are displayed in field 452. As shown, field 452 displays potential attendees 456a-c that are associated with keywords “PROJECT Q,” “STATUS,” or both. The order in which identifiers for potential attendees 456a-c may be displayed varies. By way of example, identifiers for potential attendees 456a-c may be displayed such that the identifier for potential attendee 456a which has the most keyword matches is displayed first. Alternatively, identifiers for potential attendees 456a-c may be displayed in alphabetical order based on attendee names, or identifiers for potential attendees 456a-c may be displayed in alphabetical order based on keywords, e.g., if the keywords are displayed with identifiers for potential attendees 456a-c.

In one embodiment, a user may select a potential attendee 456a-c such that an invitee field 448 is automatically populated. As shown in FIG. 4B, if the user elects to invite potential attendee 456b, the user may highlight the identifier for potential attendee 456b, indicated by 460. Once the identifier for potential attendee 456b is highlighted, the identifier for potential attendee 456b is automatically filled into field 448.

As discussed above, suggested invitees to or suggested attendees of a meeting may be listed in an order based on job titles. FIG. 4C is a block diagram representation of a GUI that displays a list of suggested attendees that is ordered by the strengths of job titles in accordance with an embodiment of the present invention. Within a GUI 436′, identifiers for suggested attendees 456a′-c′ are listed in a suggested attendee field 452 in an order that is based on the job titles of suggested attendees 456a′-c′. In one embodiment, if suggested attendee 456b′ has the highest job title amongst suggested attendees 456a′-c′, and suggested attendee 456c′ has the lowest job title amongst suggested attendees 446a′-c′, the identifier for suggested attendee 456b′ may be listed first in field 452 while the identifier for suggested attendee 456c′ may be listed last in field 452. It should be appreciated, however, that job titles or roles may be listed without accounting for seniority.

Suggested attendees of a meeting may also be listed in an order that indicates the relative association strengths of the suggested attendees. By way of example, a suggested attendee that has a high association strength because he attends a relatively high percentage of meetings with a topic or description that includes a keyword may be listed first in a field. FIG. 4D is a block diagram representation of a GUI that displays a list of suggested attendees ordered by association strengths in accordance with an embodiment of the present invention. Within a GUI 436″, a field 452 displays or lists suggested attendees 465a″-c″ in order of association strengths. As suggested attendee 465c″ has the highest association strength among suggested attendees 465a″-c″, and suggested attendee 465b″ has the lowest association strength among suggested attendees 465a″-c″, suggested attendee 465″ is listed first in field 452, while suggested attendee 465b″ is listed last.

The measurement or calculation of association strengths is performed by a user context arrangement within an overall conferencing system. FIG. 5 is a block diagram representation of a user context arrangement, e.g., user context arrangement 124 of FIG. 1 in accordance with an embodiment of the present invention. A user context arrangement 124 is arranged to generate user context information that may be used by a conferencing system to generate a list of suggested attendees to a meeting. An input/output interface 564 allows user context arrangement 124 to transmit information and to receive information, e.g., a message topic or description. In one embodiment, input/output interface 564 includes an LDAP interface that allows information such as job functions or titles to be obtained from an external directory. Functionality of a web server or similar display technology, as for example a user interface generator 566, may be included in input/output interface (as shown), or may be included as a web server or web server plug-in associated with user context arrangement 124.

An indexer 568 within user context arrangement 124 indexes information contained in a message topic or description, and allows keywords to be identified. An association arrangement 576 includes an association builder 580 and a strength module 584. In general, association arrangement 576 associates meeting attendees with keywords of the meeting and, additionally, job functions. In one embodiment, a meeting organizer may be associated with the keywords associated with the meeting that he or she is organizing. Association builder 580 may identify and build associations between meeting attendees and keywords, while strength module 584 may measure or calculate strengths of the associations. A data store 572 allows information including, but not limited to, indexes, associations, and association strengths to be stored.

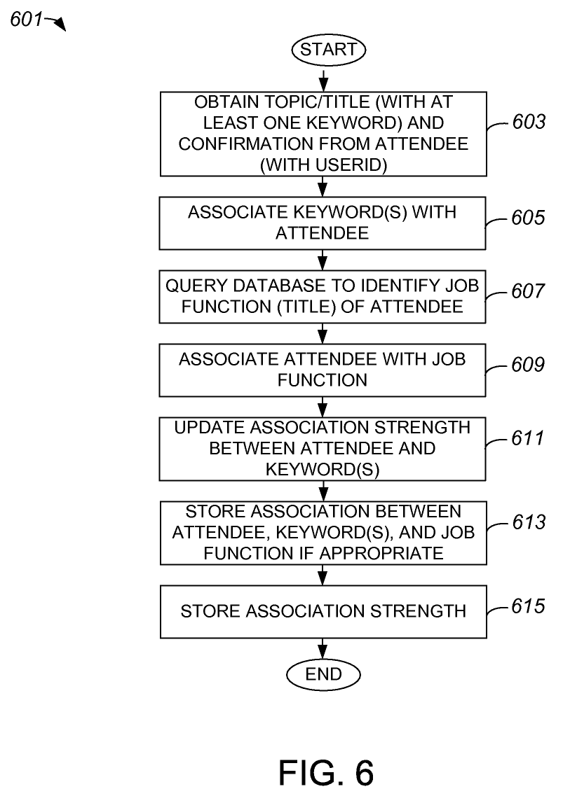

As previously mentioned, a relative association strength may be generated for each individual in relation to a keyword or a topic. An association strength for an individual, for example, who last attended a meeting on a topic six months ago may have a lower association strength than an individual who last attended a meeting on a topic one week ago. Referring next to FIG. 6, one method of generating an association strength or a ranking based on information received from a meeting attendee will be described in accordance with an embodiment of the present invention. A process 601 of generating an association strength begins at step 603 in which a topic or a title of a meeting, as well as a confirmation from a meeting attendee, is received or otherwise obtained by a conferencing system. The topic or title includes at least one keyword that is recognized and stored within a conferencing system. Typically, when a meeting attendee provides confirmation of meeting attendance, the confirmation includes an identifier such as the userid of the attendee as well as confirmation from the attendee. If a description of the meeting was provided when the meeting was scheduled, the description may be included in addition to the topic and the identifier in the confirmation.

In step 605, the keyword or keywords of the meeting are associated with the attendee. Then, in step 607, a database is queried to identify a job function or title of the attendee. The database may include a directory which uses an LDAP, and may be a database that stores profile information for all individuals associated with an enterprise. Typically, such a database is external to a conferencing system, although both the database and the conferencing system may be located within a network of the enterprise.

Once the job function of the attendee is obtained, the attendee is associated with the job function in step 609. That is, an association between the attendee and the job function is effectively created within the conferencing system. The association strength between the attendee and each keyword is updated in step 611. Updating the association strength may include determining if a ranking of relevance is to be changed. By way of example, if the attendee attends one meeting a day that involves a topic which includes a particular keyword, and the confirmation obtained in step 603 is consistent with this, then the ranking of relevance for the attendee and keyword pair may not change, as the attendee still has a high likelihood of attending meetings with topics that include the keyword. Alternatively, if the last time the attendee attended a meeting based on a topic that includes the keyword was six months ago, the ranking of relevance for the attendee and keyword pair would change to indicate a higher association strength. In general, an association strength is a measure of the strength of a relationship between a keyword and an attendee. It should be appreciated that associations may be aged such that they lose strength over time.

After the association strength between the attendee and each keyword is updated, an association between the attendee, each keyword, and job function is stored if appropriate in step 613. If the association between the attendee, each keyword, and job function has previously been stored, it may not be necessary to store the association again. The association strength may be stored in a data store of the conferencing system. The association strength is stored in step 615, e.g., in a data store of the conferencing system, and the process of generating an association strength is completed.

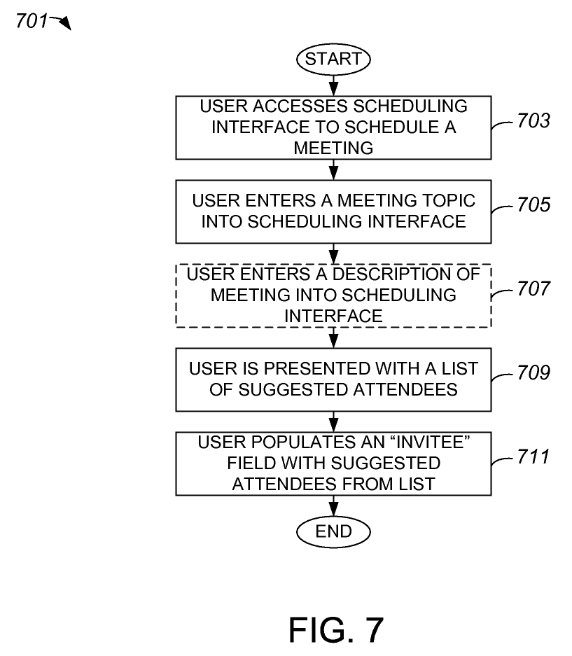

When a user accesses a scheduling interface of a conferencing system, as described above, the user is presented with a list of suggested invitees that are keyed off of keywords included in at least a meeting topic provided by the user. The invitees in the list of suggested invitees may be presented in a variety of different orders, e.g., in an order such that the suggested invitees with the highest association strengths are presented first. FIG. 7 is a process flow diagram which illustrates a method of utilizing a message scheduling interface that provides a list of suggested attendees in accordance with an embodiment of the present invention. A process 701 of utilizing a message scheduling interface begins at step 703 in which a user accesses a scheduling interface to schedule a meeting. The scheduling interface may generally be a GUI displayed on screen of a computing system that is in communication with a conferencing system.

Once the user accesses a scheduling interface, the user enters a meeting topic into the scheduling interface in step 705. The meeting topic may be entered into the scheduling interface in a variety of different ways, e.g., the user may type the meeting topic into a text field of the GUI. In one embodiment, the user may also enter a description of the meeting into the scheduling interface in step 707. However, it should be appreciated that the user may not necessarily enter a description of the meeting into the scheduling interface.

In step 709, the user is presented with a list of suggested attendees. As described above with respect to FIGS. 4A-D, the list of suggested attendees 709 may be provided in a scrolling window of a GUI. Other methods for providing the user with a list of suggested attendees may include, but are not limited to, providing list of suggested attendees in a drop-down or pop-up menu, providing the list of suggested attendees in a separate window, and providing the list of suggested attendees in a field that allows the user to check off the suggested attendees he or she wishes to invite.

The order in which the suggested attendees are presented in the list may vary. The list may be alphabetical, the list may be hierarchical with executive and managerial job functions being listed before other job functions, or the list may be ordered with higher association strengths being listed before lower association strengths. The list may also be a combination of a variety of orders, e.g., the list may be ordered primarily by association strengths such that alphabetical order is a secondary consideration and substantially only used when there is more than one individual with a given association strength.

Once the list of suggested attendees is presented to the user, the user populates an invitee field using the list of suggested attendees in step 711. In other words, the user may select relevant attendees from the list of suggested attendees. The job functions that may be included in a list of suggested attendees enables the user to determine which suggested attendees might be relevant to a meeting. For example, if a meeting topic involves addressing financial concerns of “Project Q,” an individual with the job function of “vice president of finance” may be a relevant attendee, while an individual with the job function of “engineering technician” may not be a relevant attendee. Populating the invitee field may include, but is not limited to including, typing invitee e-mail addresses into the invitee field and using an interface device such as a mouse or a touchpad to select invitee e-mail addresses that are then automatically filled into the invitee field. After the user populates the invitee field, the process of utilizing a message scheduling interface is completed.

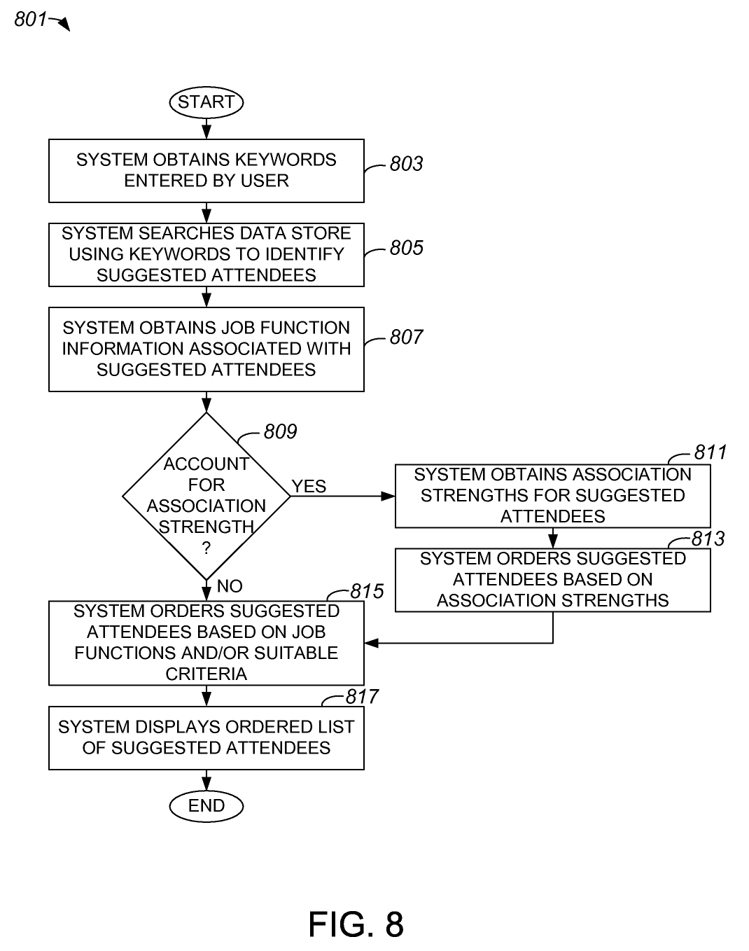

FIG. 8 is a process flow diagram which illustrates steps associated with one method of a conferencing system presenting a list of suggested attendees in accordance with an embodiment of the present invention. A process 802 of presenting a list of suggested attendees to a user begins at step 803 in which the conferencing system obtains keywords, or at least one keyword, entered by the user. The keywords may be provided to the conferencing system as part of a topic or a description of a meeting that the user is scheduling. Once the keywords are obtained, the system searches a data store in step 805 using the keywords to identify suggested attendees. By way of example, the system may index into a data store with the keywords, and identify any groups or individuals that are indicated as being associated with the keywords. Such groups or individuals may generally be identified as suggested attendees.

After suggested attendees are identified, information relating to the job functions of the suggested attendees is obtained in step 807. If job function information is not stored in the data store, which is generally part of the system, the system may access an external database, e.g., an external database that stores a member or employee directory for an enterprise, to obtain the job function information.

In step 809, it is determined if association strength is to be accounted for. By way of example, it may be determined whether the frequency with which each of the suggested attendees attends meetings associated with the keywords and/or how recently each of the suggested attendees attended a meeting associated with the keywords is to be accounted for. If it is determined that association strength is not to be accounted for, then in step 815, the system orders the suggested attendees based on job function and/or other suitable criteria. For instance, the suggested attendees may be ordered by job functions in a hierarchical order, as well as alphabetically if more than two individuals have the same job function. After the suggested attendees are ordered based at least on job function, the ordered suggested list of attendees is displayed in step 817, and the process of presenting a suggested list of attendees is completed. It should be appreciated that the list of attendees may include substantially any information, and is not limited to including an identifier for each suggested attendee, e.g., a name or a userid, and a job function for each suggested attendee.

Returning to step 809, it is determined that association strength is to be accounted for, the indication is that association strength has been determined, and is stored, by the system for each suggested attendee. Accordingly, process flow moves from step 809 to step 811 in which association strengths for each of the suggested attendees is obtained, e.g., from a data store within the system. Once the association strengths are obtained, the system orders the suggested attendees based on the association strengths 813. In one embodiment, the attendees with the highest association strengths are listed before the attendees with the lowest association strengths. Once the suggested attendees are ordered based on association strengths, additional ordering may be implemented, i.e., the ordering based on association strengths may be augmented. By way of example, if there are a plurality of suggested attendees with approximately the same association strengths, the plurality of suggested attendees may be sorted based on job function. From step 813, process flow proceeds to step 815 in which the system further orders the list of suggested attendees.

Although only a few embodiments of the present invention have been described, it should be understood that the present invention may be embodied in many other specific forms without departing from the spirit or the scope of the present invention. By way of example, a GUI that may be used by a user to schedule a meeting may vary widely. Further, an interface that a user may use to schedule a meeting is not limited to being a GUI, and may be substantially any suitable interface.

In one embodiment, an association strength may be updated based upon an issued invitation. That is, if an invitee is issued an invitation to a meeting with a topic that includes a keyword, an association strength for the relationship between the invitee and the keyword may be updated. The association strength may further be updated if the invitee actually attends the meeting or weakened if the invitee does not attend the meeting.

A variety of different factors may affect an association strength. As discussed above, an association strength may be measured by factors such as the frequency with which an invitee attended meetings identified at least in part by a keyword, and/or the most recent time an invitee attended a meeting identified at least in part by a keyword. Other factors that may be measures of an association strength may include, but are not limited to including, the number of relevant keywords an invitee is associated with and/or the frequency with which the invitee attended meetings identified at least in part by a keyword within a particular time frame.

While an indication that an attendee is in attendance at a meeting effectively initiates a process of associating the attendee with a topic or, more generally, a keyword for the meeting, such a process may instead be initiated by the acceptance of a meeting. In other words, the act of an invitee indicating interest or intended attendance at a meeting may cause the invitee to be associated with a keyword for the meeting. Generally, a meeting organizer, e.g., the person who selects actual invitees to a meeting, may be associated with a keyword for the meeting he or she is organizing.

Words that are related to keywords may be accounted for when associations between keywords and entities are to be identified. For example, while an association between a keyword “status” and an invitee may be stored in a conferencing system, the conferencing system may account for related keywords such as “update” and “progress report.” That is, an association between the keyword “status” and an invitee may be considered to also be an association between the keyword “update” and the invitee, as well as an association between the keywords “progress report” and the invitee.

Including a job function for a suggested invitee or a suggested attendee for a meeting enables a user who is using a meeting scheduler arrangement to readily identify the roles of each suggested invitee and, further, to determine which suggested invitees may be particularly relevant to the meeting. However, it should be appreciated that the job functions of suggested invitees are not necessarily presented to the user.

The steps associated with the methods of the present invention may vary widely. Steps may be added, removed, altered, combined, and reordered without departing from the spirit of the scope of the present invention. Therefore, the present examples are to be considered as illustrative and not restrictive, and the invention is not to be limited to the details given herein, but may be modified within the scope of the appended claims.

What is claimed is:

1. Logic encoded in one or more tangible media for execution and when executed operable to:
receive a keyword, the keyword being associated with a meeting;
store information associated with the plurality of entities in a data store;
search the data store to determine if a first association between the keyword and a first entity of the plurality of entities is included in the information; and
identify the first entity as a suggested attendee for the meeting if it is determined that the association between the keyword and the entity is present in the data store.

2. The logic of claim 1 wherein the logic operable to receive the keyword is further operable to receive the keyword in at least one selected from a group including a first string that indicates a meeting topic and a second string that indicates a meeting description.

3. The logic of claim 2 further operable to:
index the at least one selected from the group including the first string and the second string to identify the keyword.

4. The logic of claim 1 wherein the logic operable to search the data store to determine if the first association between the keyword and the first entity is present in the data store is further operable to search the data store to determine if a second association between the keyword and a second entity of the plurality of entities is present in the data store.

5. The logic of claim 4 further operable to:
identify a first association strength for the first association and a second association strength for the second association;
determine if the first association strength is higher than the second association strength; and
create a list that includes a first identifier for the first entity and a second identifier for the second entity, wherein if the first association strength is determined to be higher than the second association strength, the first entity is ordered in the list ahead of the second entity.

6. The logic of claim 5 wherein the first association strength is an indication of an attendance record of the first entity, the attendance record being arranged to indicate attendance of meetings that are at least partially described by the keyword.

7. The logic of claim 4 further operable to:
obtain a first title associated with the first entity;
obtain a second title associated with the second entity;
determine if the first title is hierarchically above the second title; and
create a list that includes a first identifier for the first entity and a second identifier for the second entity, wherein if the first title is determined to be hierarchically above the second title, the first entity is ordered in the list ahead of the second entity.

8. A conferencing system, the conferencing system being accessible to a plurality of entities, the conferencing system comprising:
means for receiving a keyword associated with a meeting;
means for storing information associated with the plurality of entities;
means for determining if a first association between the keyword and a first entity of the plurality of entities is included in the information; and
means for identifying the first entity as a suggested attendee for the meeting if it is determined that the association between the keyword and the entity is present in the data store.

9. A method for scheduling a meeting using a conferencing system, the conferencing system including a data store, the method comprising:
identifying a keyword;
determining if a first association between the keyword and a first entity is stored in the data store; and
identifying the first entity as a suggested attendee for the meeting if it is determined that the first association between the keyword and the first entity is stored in the data store.

10. The method of claim 9 wherein identifying the keyword includes obtaining the keyword from at least one selected from a group including a first string that indicates a meeting topic and a second string that indicates a meeting description.

11. The method of claim 9 further including:
determining if a second association between the keyword and a second entity is stored in the data store; and
identifying the second entity as a suggested attendee for the meeting if it is determined that the second association between the keyword and the second entity is stored in the data store.

12. The method of claim 11 further including:
determining if a strength of the first association is higher than a strength of the second association; and
creating a list that includes a first identifier for the first entity and a second identifier for the second entity, wherein if the strength of the first association is determined to be higher than the strength of the second association, the first entity is ordered in the list ahead of the second entity.

13. The method of claim 11 further including:
obtaining a first title associated with the first entity;
obtaining a second title associated with the second entity;
determine if the first title is higher in a title hierarchy than the second title; and
creating a list that includes a first identifier for the first entity and a second identifier for the second entity, wherein if the first title is determined to be higher in a title hierarchy than the second title, the first entity is ordered in the list ahead of the second entity.

14. Logic encoded in one or more tangible media for execution and when executed operable to:
receive a confirmation message, the confirmation message being indicative of an attendance of a meeting by a first invitee, the meeting being at least partially identified by a keyword, wherein the confirmation message includes the keyword and an identifier that identifies the first invitee;
determine whether the keyword has an association with the first invitee, wherein the first invitee is an attendee;
update the association between the keyword and the attendee if the determination is that the keyword has the association with the attendee;
create the association between the keyword and the attendee if the determination is that the keyword does not have the association with the attendee; and
store the association between the keyword and the attendee.

15. The logic of claim 14 further operable to:
identify a title of the attendee, wherein the logic operable to store the association between the keyword and the attendee is further operable to store the title with the association between the keyword and the attendee.

16. The logic of claim 15 wherein the logic operable to identify the title of the attendee is further operable to obtain the title of the attendee from a directory.

17. The logic of claim 14 further operable to:
determine a strength of the association between the keyword and the attendee; and
store the strength.

18. A conferencing system, the conferencing system being arranged to set up a meeting and to invite a first invitee to attend the meeting, the meeting being at least partially identified by a keyword, the conferencing system comprising:
means for obtaining a confirmation message, the confirmation message being indicative of an attendance of the meeting by the first invitee, wherein the confirmation message includes the keyword and an identifier that identifies the first invitee;
means for determining whether the keyword has an association with the attendee;
means for updating the association between the keyword and the attendee if the determination is that the keyword has the association with the attendee;
means for creating the association between the keyword and the attendee if the determination is that the keyword does not have the association with the attendee; and
means for storing the association between the keyword and the attendee.

19. A method comprising:
obtaining a confirmation message, the confirmation message being indicative of an attendance of the meeting by the first invitee, wherein the confirmation message includes the keyword and an identifier that identifies the first invitee;
determining whether the keyword has an association with the attendee;
updating the association between the keyword and the attendee if it is determined that the keyword has the association with the attendee;
creating the association between the keyword and the attendee if it is determined that the keyword does not have the association with the attendee; and
storing the association between the keyword and the attendee.

20. The method of claim 19 further including:
identifying a title of the attendee, wherein storing the association between the keyword and the attendee includes storing the title with the association between the keyword and the attendee.

21. The method of claim 20 wherein identifying the title of the attendee includes obtaining the title of the attendee from a directory.

22. The method of claim 19 further including:
determining a strength of the association between the keyword and the attendee; and
storing the strength.
